(19) United States
(12) Patent Application Publication
(10) Pub. No.: US 2023/0228562 A1
(43) Pub. Date: Jul. 20, 2023

(54) METHOD FOR MEASURING SUPER-LARGE DEFORMATION OF PLANE

(71) Applicant: Chongqing University, Chongqing (CN)

(72) Inventors: Zhanfang LIU, Chongqing (CN); Tao HE, Chongqing (CN)

(73) Assignee: Chongqing University, Chongqing (CN)

(21) Appl. No.: 18/098,113

(22) Filed: Jan. 18, 2023

(30) Foreign Application Priority Data
Jan. 19, 2022 (CN) 202210062647.1

(51) Int. Cl. G01B 11/16; G01M 11/08; G06T 7/149

(52) U.S. Cl. CPC G01B 11/167; G01M 11/081; G06T 7/149; G06T 2207/30208

(57) ABSTRACT

A method includes the steps of arranging mark points for image recognition on a plane of a test piece to be measured; recognizing and recording positions of two-dimensional Cartesian coordinates of each mark point of the test piece to be measured before and after each stretching; and determining a deformation gradient of each mark point and deformation measurement parameters of each mark point through a numerical method, where the deformation measurement parameters include a deformation gradient matrix, an elongation tensor matrix, a finite strain tensor matrix, an orthogonal tensor matrix, an angular tensor matrix, a rotation angle, and a curvature. According to the method, objective measurement of super-large deformation of the plane relating to rotation deformation is achieved.

CROSS REFERENCE TO THE RELATED APPLICATIONS

This application is based upon and claims priority to Chinese Patent Application No. 202210062647.1, filed on Jan. 19, 2022, the entire contents of which are incorporated herein by reference.

### TECHNICAL FIELD

The present invention belongs to the technical field of measurement of super-large deformation, and particularly provides a method for measuring super-large deformation of a plane, which is suitable for, but not limited to, measurement of super-large deformation of a plane of rubber, biological tissues, rock and soil materials, metal forming, etc.

### BACKGROUND

Materials such as rubber, foam, polymers and biological tissues including skin, blood vessels, etc. have such deformation characteristics that deformation is super-large and shows extremely uneven localization features, resulting in that processing cannot be performed by using a method for approximately uniform small deformation.

At present, people use a large number of measurement and analysis methods for super-large deformation, however, a unified measurement standard is lacked, and therefore, objective measurement and objective comparison of deformation degrees of the super-large deformation cannot be performed. Due to lack of a unified measurement standard for large deformation, it is difficult to determine objective internal force corresponding to the deformation, and it is difficult to determine and evaluate mechanical properties of the super-large deformation materials, thereby seriously restricting application of the large-deformation materials in the related industrial field and the military industry.

At present, due to the lack of the unified measurement standard, measurement of ultra-large deformation of materials mainly refers to the national standard GB/T528-2009 “Rubber, vulcanized or thermoplastic-Determination of tensile stress-strain properties”. However, the standard can only measure two material parameter indexes of force and elongation required during a tensile process and fracture of a test sample, and cannot perform deformation characterization and geometric measurement on the large-deformation materials, and therefore, help with practical application and engineering design is limited.

### SUMMARY

An objective of the present invention is to theoretically and technically put forward a new method for measuring super-large deformation of a plane, which introduces rotation deformation during consideration of super-large tensile deformation, thereby performing objective measurement of deformation degrees of the super-large deformation of the plane.

The method for measuring super-large deformation of a plane in the present invention includes:

arranging mark points for image recognition on a plane to be measured;

recognizing and recording positions of two-dimensional Cartesian coordinates of each mark point on the plane to be measured before and after each stretching; and

determining a deformation gradient matrix of each mark point by using a numerical method so as to determine other deformation measurement parameters,

where the deformation measurement parameters further include;

at least one of an elongation tensor matrix and a finite strain tensor matrix; and

at least one of an orthogonal tensor matrix, an angular tensor matrix and a rotation angle.

Furthermore, a curvature C of one mark point is calculated according to the rotation angles of two adjacent mark points.

The deformation gradient matrix [F] of each mark point is calculated. If a forward difference method is used, an instance is shown as follows:

any mark point is taken as P₁, the adjacent mark point of the mark point in an X-axis direction is P₂, the adjacent mark point in a Y-axis direction is P₄, and the coordinates before deformation are (X₁, Y₁), (X₂, Y₂) and (X₄, Y₄) respectively. For the three mark points, the coordinates after deformation are (x₁, y₁), (x₂, y₂) and (x₄, y₄) respectively.

The deformation gradient matrix of mark point P₁ is:

$$[ {F}_{1} ] = [ \begin{matrix}{F}_{11} & {F}_{12} \\ {F}_{21} & {F}_{22}\end{matrix} ] = [ \begin{matrix}\frac{{x}_{2} - {x}_{1}}{{X}_{2} - {X}_{1}} & \frac{{x}_{4} - {x}_{1}}{{Y}_{4} - {Y}_{1}} \\ \frac{{y}_{2} - {y}_{1}}{{X}_{2} - {X}_{1}} & \frac{{y}_{4} - {y}_{1}}{{Y}_{4} - {Y}_{1}}\end{matrix} ] .$$

Furthermore, formulas of

[U]=\sqrt{[F]^{T}·[F]}

[V]=\sqrt{[F]·[F]^{T}}

are used for determining a right elongation tensor matrix [U] and a left elongation tensor matrix [V] of this mark point.

Furthermore, formulas of

[H]=ln[U]

[h]=ln[V]

are used for determining the finite strain tensor matrix of this mark point, that is, a right strain tensor matrix [H] and a left strain tensor matrix [h].

Furthermore, a formula of

[R]=[F]·[U]⁻¹

is used for determining the orthogonal tensor matrix [R] of this mark point.

Furthermore, a formula of

$$[ A ] = ln [ R ] = [ \begin{matrix}0 & {A}_{12} \\ - {A}_{12} & 0\end{matrix} ]$$

is used for obtaining the angular tensor matrix [A] of this mark point, and

the rotation angle of this mark point is determined to be α=−A₁₂.

Furthermore, two components of the curvature C of mark point P₁ are C₁₁ and C₁₂ respectively, specific calculations are as follows:

$${C}_{11} = \frac{{α}_{2} - {α}_{1}}{{X}_{2} - {X}_{1}} , {C}_{12} = \frac{{α}_{4} - {α}_{1}}{{Y}_{4} - {Y}_{1}} ,$$

and

α₁, α₂ and α₄ are rotation angles corresponding to P₁, P₂ and P₄ respectively.

Furthermore, all the mark points are uniformly distributed on one part or all parts of the plane to be measured.

Furthermore, the method further includes the step of performing a pre-stretching operation on the plane to be measured in a natural state to obtain a plane to be measured in a tensioned state as a whole in a stretching direction, where coordinate positions of mark points on the plane to be measured in such a state serve as initial positions of the mark points.

Furthermore, coordinate positions of centroids of all the mark points serve as coordinate positions of the mark points.

Furthermore, the mark points are almost circular, and a ratio of a mark point diameter to mark point spacing is about 1:2 to 1:4.

The method has the beneficial effects as follows: according to the present invention, rotation deformation is introduced when the super-large tensile deformation is considered, such that deformation characterization and geometric measurement of super-large deformation are achieved. The deformation gradient of the deformation degree of each mark point is calculated by using coordinate change of each mark point. The elongation tensor describes the tensile variation of a line element, the variation is divided into right elongation tensor and left elongation tensor, the tensile variation before rotation of the line element is described as the right elongation tensor, and the tensile variation after rotation of the line element is described as the left elongation tensor. The orthogonal tensor describes bending of the line element, that is rotation deformation. The finite strain tensor is a natural logarithm of the elongation tensor, that is, the logarithmic strain configured to measure the tensile deformation degree of the line element. The angular tensor is a natural logarithm of the orthogonal tensor and is configured to express an axis and a rotation angle of the rotation deformation of the line element, and the rotation angle α is a vector expression of the angular tensor. The curvature C is used for measuring the degree of bending or rotation deformation of the line element. Therefore, the super-large deformation involved in the present invention has the characteristics of both tensile deformation and continuous rotation deformation. Since deformation characterization parameters relating to the rotation deformation are introduced and the measurement method is provided, objective measurement of the super-large deformation of the plane is achieved; and quantitative measurement of the rotation angle and the curvature is provided, and therefore, a scientific and effective solution is provided for research and measurement of super-large deformation mechanical performance parameters of materials.

### BRIEF DESCRIPTION OF THE DRAWINGS

FIGS. 1A and 1B show a schematic diagram of standard mark points of a test piece in an example of the present invention.

FIG. 2 is a schematic diagram of standard mark points of a test piece after stretching loading in an example of the present invention.

FIG. 3 is a digital image of a standard mark point test piece of a super-large deformation material before stretching in an example of the present invention.

FIG. 4 is a digital image of a standard mark point test piece of a super-large deformation material after stretching in an example of the present invention.

FIG. 5A is a schematic diagram of mark point distribution of a standard mark point test piece of a super-large deformation material before deformation in an example of the present invention.

FIG. 5B is a schematic diagram of mark point distribution of a standard mark point test piece of a super-large deformation material after deformation in an example of the present invention.

FIG. 6 is a vector diagram of a principal axis and a main value of a right elongation tensor matrix [U] in an example of the present invention.

FIG. 7 is a vector diagram of a principal axis and a main value of a left elongation tensor matrix [V] in an example of the present invention.

FIG. 8 is a vector diagram of a principal axis and a main value of a right strain tensor matrix [H] in an example of the present invention.

FIG. 9 is a vector diagram of a principal axis and a main value of a left strain tensor matrix [h] in an example of the present invention.

FIG. 10 is a schematic diagram representing a rotation angle a of each mark point with an included angle between vectors in an example of the present invention.

### DETAILED DESCRIPTION OF THE EMBODIMENTS

In the example, by means of a geometric parameter measurement process of super-large deformation of a plane of a material test piece, the measurement method in the present invention is illustratively described.

1. Manufacturing of Mark Point Test Piece

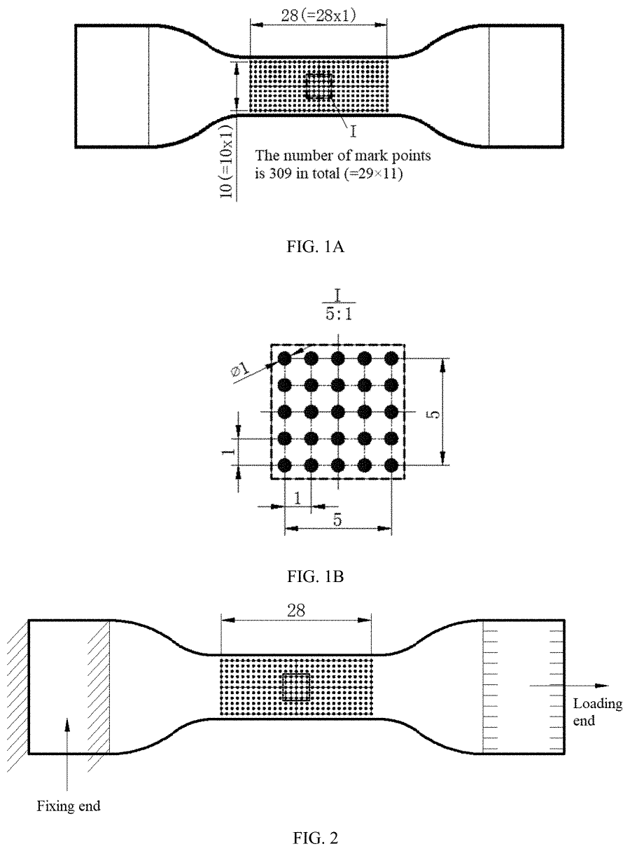

According to the example of the present invention, the designed and manufactured material standard mark point test piece is of a dumbbell-shaped sheet structure as a whole, the periphery of the material standard mark point test piece is cut neatly, and circular mark points are printed in a middle effective deformation area so as to provide regular recognition mark points for digital image measurement. The specific manufacturing method includes the steps: firstly, designing a dumbbell-shaped test piece structure as shown in FIGS. 1A and 1B; then performing accurate cutting according to a design size thereof by using a carving knife; and finally, spraying 319 solid round points with a diameter of 0.5 mm in total under assistance of a special sample point jet printing mold at an effective elongation part of the test piece, where each row has 29 solid round points in a transverse direction, each column has 11 solid round points in a longitudinal direction, and transverse and longitudinal distances each are 1 mm.

2. Test Piece Stretching and Acquisition of Digital Images

The manufactured mark point test piece is clamped on a tensile testing machine, and the test piece is stretched and loaded as shown in FIG. 2 in a forced displacement (or load force) manner. After the test piece is firmly clamped, the tightness condition of the test piece is observed in a photographing direction, and the test piece is pre-stretched by using a point movement small-step-distance loading mode until the whole test piece is in a tensioned state in a stretching direction.

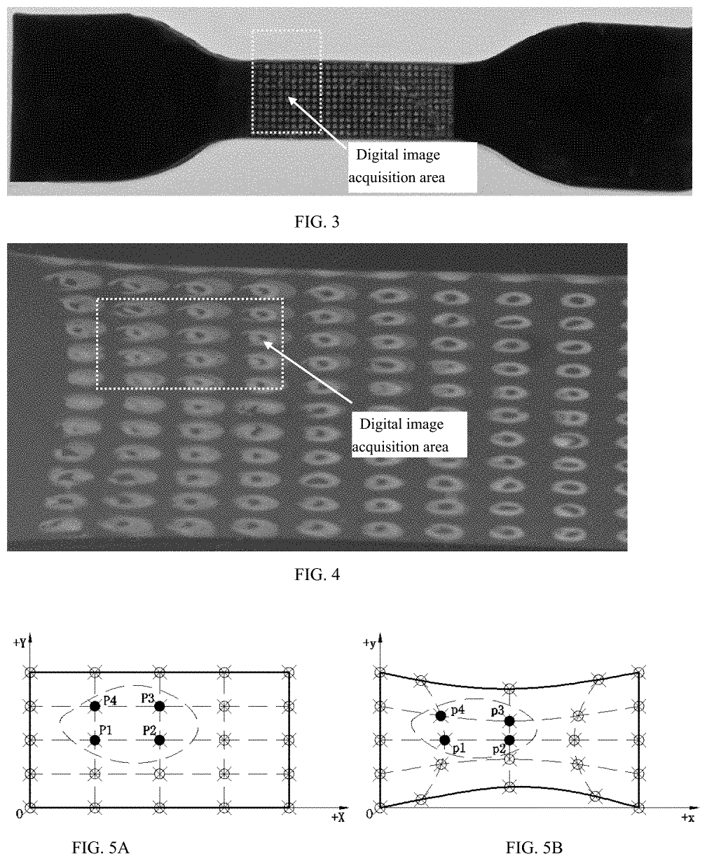

After the pre-stretching is completed, the state is marked as an initial state, and a digital image in the initial state is shown in FIG. 3. Then the state is marked as a current deformation state 1, a deformation state 2, . . . , in sequence. Each state is maintained for 5 minutes. A surface deformation distribution condition of the test piece is observed with naked eyes. After surface deformation of the test piece tends to be stable, a test piece mark point image with a clear contour as shown in FIG. 4 is selected as a test piece mark point image of the current deformation state, and the test piece mark point image is named and saved one by one according to the sequence of the stretching states. In a test process, the number of stretching times is reasonably determined according to tensile properties and test measurement requirements of the test piece, and in this example, before the surface of the test piece is found to be damaged, there are generally no less than five states.

3 Recognition and Coding of Test Piece Mark Points

In this embodiment, centroid position coordinates of the mark points serve as coordinate values of the mark points. In order to obtain centroid position data of the mark points of the test piece, the digital image of the mark points of the test piece is processed by using a digital image processing technology, which may employ but not limited to the following steps:

(1) Image Preprocessing

Operations such as noise suppression and filtering restoration on an original digital image acquired in the stretching process of the test piece, and real information of the position change of the mark points in the deformation process of the test piece is reduced to the maximum extent. By using an image enhancement technology, the definition and contrast of contours of mark point edges of the test piece are further improved, thereby highlighting edge information of the mark points.

(2) Image Segmentation

The mark points on the test piece image are segmented from a test piece background, and mark point edge contour information is obtained so as to provide basic data for image recognition. The main process includes the steps of firstly reading a grayscale image of the test piece, then performing edge detection by using a differential operator such as Sobel, Prewitt and Roberts, next, performing a threshold normalization operation, and finally obtaining a binary image with only black and white colors.

(3) Image Stitching

Feature point extraction is performed on each image by using several mark point images in a certain stretching state, then matching is performed on feature points one by one, next, the matching image is copied to a specific position on another image, and finally, fusion processing is performed on an overlapping boundary to form a new image with natural transition.

(4) Image Recognition

For the image subjected to mark point edge information acquisition of the test piece after image segmentation, 8 connected domain numbering and marking are performed on all pixels belonging to the same pixel connected domain, thereby returning a pixel number matrix. According to a centroid algorithm, coordinate data of each mark point centroid on the test piece image is obtained by performing loop iterative computation on all mark point edge pixel matrices on the test piece image.

(5) Mark Point Ordering and Coding

Positions of a row and column of each mark point, and the total number of the mark points on the test piece image are numbered. For coordinate data in X and Y directions, associated matching and ordering are performed according to spatial distribution positions in the test piece, and summarization is performed to form coordinate data of the mark points, rows and columns of the positions, and an n×5 matrix of serial numbers of the total number of the mark points.

More methods and technologies for recording two-dimensional Cartesian coordinate positions before and after stretching of each mark point are well known to those skilled in the art, which are not repeated herein. However, no matter what kind of coordinate positions are used to determine the technical solutions, and none of these technical solutions exceeds the protection scope of the present invention.

4. Calculation of Metric Parameters of super-large deformation of plane

Image recognition is performed on the mark points in the image according to the digital image after stretching of the test piece to obtain plane coordinate data of each mark point. Geometric metric parameters such as the deformation gradient [F], the right elongation tensor matrix [U], the left elongation tensor matrix [V], the orthogonal tensor matrix [R], the right elongation strain matrix [H], the left elongation strain matrix [h], the angular tensor matrix [A], the rotation angle a and the curvature C of each mark point in different stretching states are calculated. Detailed description will be made below with reference to specific calculation examples.

In the case, only 4 mark points, that is P₁, P₂, P₃ and P₄, of any area inside the test piece are selected, the coordinates before deformation are (X₁, Y₁), (X₂, Y₂), (X₃, Y₃) and (X₄, Y₄), and the coordinates after deformation are (x₁, y₁), (x₂, y₂), (x₃, y₃) and (x₄, y₄). Coordinate origins of all the mark points in the plane of the test piece before and after deformation are located at lower left corners, coordinate data of mark points P₁, P₂, P₃ and P₄ before and after deformation are shown in Table 1, and distribution positions in the plane of the test piece are shown in FIG. 5A and FIG. 5B.

TABLE 1
Coordinate data of mark points before and after deformation

| | Coordinates before | | Coordinates after | |
|---|---|---|---|---|
| Serial numbers | deformation | | deformation | |
| of mark | (mm) | | (mm) | |
| points | X | Y | x | y |
| P₁ | 71.25 | −9.75 | 148.86 | −6.9214 |
| P₂ | 71.75 | −9.75 | 149.87 | −6.9385 |
| P₃ | 71.75 | −9.25 | 149.64 | −6.5764 |
| P₄ | 71.25 | −9.25 | 148.62 | −6.5613 |

4.1 Deformation Gradient

With the coordinate positions of 4 mark points P₁, P₂, P₃ and P₄ in FIGS. 5A and 5B before and after deformation as instances, a method for calculating the deformation gradient is now illustratively described. In the example, the deformation gradient of each mark point is calculated according to a finite difference method, that is, the deformation gradient of each mark point is calculated by using each mark point and the coordinate positions before and after stretching of the two adjacent mark points of the mark point. When the mark point does not have a forward difference in a certain coordinate axis direction, calculation of the deformation gradient is performed in a backward difference manner. For tensile deformation of the planar test piece, the method for determining the deformation gradient is divided into the following four types of conditions:

(1) if mark point P₁ is located at a lower left corner of a mark point area or an internal mark point area, a forward difference condition is satisfied, and the calculation expression is:

$$[ {F}_{1} ] = [ \begin{matrix}{F}_{11} & {F}_{12} \\ {F}_{21} & {F}_{22}\end{matrix} ] = [ \begin{matrix}\frac{{x}_{2} - {x}_{1}}{{X}_{2} - {X}_{1}} & \frac{{x}_{4} - {x}_{1}}{{Y}_{4} - {Y}_{1}} \\ \frac{{y}_{2} - {y}_{1}}{{X}_{2} - {X}_{1}} & \frac{{y}_{4} - {y}_{1}}{{Y}_{4} - {Y}_{1}}\end{matrix} ] ;$$

(2) if mark point P₂ is located at a right boundary of the mark point area and a non-upper right corner, the deformation gradient [F₂] of P₂ needs to be calculated according to the backward difference in an X direction and calculated according to the forward difference in a Y direction, and the calculation expression is:

$$[ {F}_{2} ] = [ \begin{matrix}{F}_{11} & {F}_{12} \\ {F}_{21} & {F}_{22}\end{matrix} ] = [ \begin{matrix}\frac{{x}_{2} - {x}_{1}}{{X}_{2} - {X}_{1}} & \frac{{x}_{3} - {x}_{2}}{{Y}_{3} - {Y}_{2}} \\ \frac{{y}_{2} - {y}_{1}}{{X}_{2} - {X}_{1}} & \frac{{y}_{3} - {y}_{2}}{{Y}_{3} - {Y}_{2}}\end{matrix} ] ;$$

(3) if mark point P₄ is located at a left boundary and a non-lower left corner, the deformation gradient [F₄] of P₄ is calculated according to the forward difference in the X direction and is calculated according to the backward difference in the Y direction, and the calculation expression is:

$$[ {F}_{4} ] = [ \begin{matrix}{F}_{11} & {F}_{12} \\ {F}_{21} & {F}_{22}\end{matrix} ] = [ \begin{matrix}\frac{{x}_{3} - {x}_{4}}{{X}_{3} - {X}_{4}} & \frac{{x}_{4} - {x}_{1}}{{Y}_{4} - {Y}_{1}} \\ \frac{{y}_{3} - {y}_{4}}{{X}_{3} - {X}_{4}} & \frac{{y}_{4} - {y}_{1}}{{Y}_{4} - {Y}_{1}}\end{matrix} ] ;$$

and

(4) when mark point P₃ is located at an upper right corner of the test piece to be measured, the deformation gradient [F₃] of P₃ is calculated according to the backward difference in the X direction and the Y direction, and the calculation expression is:

$$[ {F}_{3} ] = [ \begin{matrix}{F}_{11} & {F}_{12} \\ {F}_{21} & {F}_{22}\end{matrix} ] = [ \begin{matrix}\frac{{x}_{3} - {x}_{4}}{{X}_{3} - {X}_{4}} & \frac{{x}_{3} - {x}_{2}}{{Y}_{3} - {Y}_{2}} \\ \frac{{y}_{3} - {y}_{4}}{{X}_{3} - {X}_{4}} & \frac{{y}_{3} - {y}_{2}}{{Y}_{3} - {Y}_{2}}\end{matrix} ] .$$

Calculation data of the deformation gradient of mark points P₁, P₂, P₃ and P₄ of the test piece is shown in Table 2, and a calculation method for the deformation gradient of the remaining mark points on the plane of the test piece are similar to the above four types of situations.

TABLE 2
Deformation gradient data of mark points

| Serial numbers of | | | | |
|---|---|---|---|---|
| mark points | F11 | F12 | F21 | F22 |
| P₁ | 2.0200 | −0.4800 | −0.0342 | 0.7202 |
| P₂ | 2.0200 | −0.4600 | −0.0342 | 0.7242 |
| P₃ | 2.0400 | −0.4600 | −0.0302 | 0.7242 |
| P₄ | 2.0400 | −0.4800 | −0.0302 | 0.7202 |

4.2 Elongation Tensor

According to a formula:

$$[ U ] = \sqrt{{[ F ]}^{T} \cdot [ F ]} = [ \begin{matrix}{U}_{11} & {U}_{12} \\ {U}_{21} & {U}_{21}\end{matrix} ]$$

the right elongation tensor matrix [U] is calculated to obtain U₁₁, U₁₂, U₂₁ and U₂₂.

According to a formula:

$$[ V ] = \sqrt{[ F ] \cdot {[ F ]}^{T}} = [ \begin{matrix}{V}_{11} & {V}_{12} \\ {V}_{21} & {V}_{22}\end{matrix} ]$$

the left elongation tensor matrix [V] is calculated to obtain V₁₁, V₁₂, V₂₁ and V₂₂.

With the right elongation tensor matrix [U] and the left elongation tensor matrix [V] of mark point P₁ as instances, calculation methods for the remaining mark points are the same as the above calculation methods. The data of the elongation tensor matrix of P₁ in the example is shown in Table 3.

TABLE 3
Various elements about [U] and [V] of elongation tensor matrix of mark point P₁

| U₁₁ | U₁₂ | U₂₁ | U₂₂ | V₁₁ | V₁₂ | V₂₁ | V₂₂ |
|---|---|---|---|---|---|---|---|
| 1.9883 | −0.3581 | −0.3581 | 0.7880 | 2.0708 | −0.1494 | −0.1494 | 0.7054 |

4.3 Finite Strain Tensor

According to a formula:

$$[ H ] = ln [ U ] = [ \begin{matrix}{H}_{11} & {H}_{12} \\ {H}_{21} & {H}_{22}\end{matrix} ]$$

the right strain tensor matrix [H] is calculated to obtain H₁₁, H₁₂, H₂₁ and H₂₂.

According to a formula:

$$[ h ] = ln [ V ] = [ \begin{matrix}{h}_{11} & {h}_{12} \\ {h}_{21} & {h}_{22}\end{matrix} ]$$

the left strain tensor matrix [h] is calculated to obtain h₁₁, h₁₂, h₂₁ and h₂₂.

In the example, with the right strain tensor matrix [H] and the left strain tensor matrix [h] of mark point P₁ as instances, the calculation methods for the remaining mark points are the same as the above calculation methods. The data of the strain tensor matrix of P₁ in the example is shown in Table 4.

TABLE 4
Various elements about [H] and [h] of strain tensor matrix of mark point P₁

| H₁₁ | H₁₂ | H₂₁ | H₂₂ | h₁₁ | h₁₂ | h₂₁ | h₂₂ |
|---|---|---|---|---|---|---|---|
| 0.6575 | −0.2839 | −0.2839 | −0.2939 | 0.7229 | −0.1184 | −0.1184 | −0.3594 |

4.4 Components of Angular Tensor Matrix, Rotation Angle and Curvature

According to a formula:

$$[ R ] = [ F ] \cdot {[ U ]}^{- 1} = {[ V ]}^{- 1} \cdot [ F ] = [ \begin{matrix}{R}_{11} & {R}_{12} \\ {R}_{21} & {R}_{22}\end{matrix} ] ,$$

the orthogonal tensor matrix [R] is calculated to obtain R₁₁, R₁₂, R₂₁ and R₂₂.

According to a formula:

$$[ A ] = ln [ R ] = [ \begin{matrix}0 & {A}_{12} \\ - {A}_{12} & 0\end{matrix} ]$$

the angular tensor matrix [A] is calculated to obtain an independent component A₁₂, and the rotation angle of the mark point is α=−A₁₂. In the example, various elements of the orthogonal tensor matrix [R] and the angular tensor matrix [A] of mark point P₁ are shown in FIGS. 5A and 5B.

TABLE 5
Various elements of orthogonal tensor matrix [R]
and angular tensor matrix [A]

| R₁₁ | R₁₂ | R₂₁ | R₂₂ | A₁₁ | A₁₂ | A₂₁ | A₂₂ |
|---|---|---|---|---|---|---|---|
| 0.9870 | −0.1606 | 0.1606 | 0.9870 | 0 | −0.1613 | 0.1613 | 0 |

The curvature of mark point P₁ is calculated by using the difference method, and the curvature is calculated according to the forward or backward difference scheme of the deformation gradient mentioned above. According to rotation angles α₁, α₂ and α₄ corresponding to the three mark points P₁, P₂ and P₄, the two components C₁₁ and C₁₂ of mark point P₁ are calculated, that is,

$${C}_{11} = \frac{{α}_{2} - {α}_{1}}{{X}_{2} - {X}_{1}} and {C}_{12} = \frac{{α}_{4} - {α}_{1}}{{Y}_{4} - {Y}_{1}} .$$

Calculation results of the two curvature components C₁₁ and C₁₂ of mark point P₁ are shown in Table 6.

TABLE 6
Rotation angle α and two curvature components of mark point P₁

| | | | | | | | | Rotation | | |
|---|---|---|---|---|---|---|---|---|---|---|
| Adjacent mark points | | | | Rotation angle of adjacent | | | | angle | Curvature C | |
| Coordinates before deformation (mm) | | | | mark points (rad) | | | | α (deg) | (rad/mm) | |
| X₂ | X₁ | Y₄ | Y₁ | α₂ | α₁ | α₄ | α₁ | α₁ | C₁₁ | C₁₂ |
| 71.75 | 71.25 | −9.25 | −9.75 | −0.1539 | −0.1613 | −0.1615 | −0.1613 | −9.242 | 0.0148 | 0.0004 |

The state of an object before deformation is of a reference configuration, and the deformed state after being stressed is a current configuration. According to the example, geometric metric parameters characterizing the deformation are calculated by using the change of the two configurations, where

(1) the deformation gradient [F] describes the degree of deformation occurring near a mass point, that is, the change degree of a line element of a deformation body, the line element before and after deformation has both the tension and pressing change and the bending change, the product of the deformation gradient is decomposed into elongation tensor and orthogonal tensor, and the elongation tensor is divided into right elongation tensor [U] and left elongation tensor [V];

(2) the right elongation tensor [U] describes the tension and pressing change before rotation of the line element, and the left elongation tensor [V] describes the tension and pressing change after rotation of the line element;

(3) the orthogonal tensor [R] describes the bending change of the line element, that is, rotation deformation;

(4) the finite strain tensor is divided into right elongation strain tensor [H] and left elongation strain tensor [h], and is a natural logarithm of the elongation tensor so as to measure the tensile deformation degree of the line element;

(5) the angular tensor [A] is a natural logarithm of the orthogonal tensor [R] and is configured to determine an axis and a rotation angle of the rotation deformation of the line element;

(6) the rotation angle a is a vector expression of the angular tensor [A]; and

(7) the curvature C is configured to measure the degree of bending or rotation deformation of the line element.

What is described above shows that the present invention relates to the tensile deformation and the rotation deformation of the super-large deformation, and objective measurement of the super-large deformation of the plane is achieved. In the example, according to an innovative plane super-large deformation geometric measurement method, the mark point test piece is designed and manufactured, each mark point and coordinates thereof are recognized by means of images before and after stretching of the test piece so as to obtain the deformation measurement parameters such as the deformation gradient, the elongation tensor, the strain tensor, the orthogonal tensor, the rotation angle and the curvature of the super-large deformation of the materials, and the problems existing in the super-large deformation geometric measurement are solved in the aspect of principles and methods.

For graphic display of the deformation measurement parameters of large deformation of the plane, the example calculates a main value and a principal axis for each tensor matrix.

Main values and principal axes of the right elongation tensor matrix [U] are calculated to obtain and the main values λᵤ₁ and λᵤ₂, and the corresponding principal axes are pᵤ₁₁, pᵤ₁₂, pᵤ₂₁, and pᵤ₂₂ respectively. Main values and principal axes of the left elongation tensor matrix [V] are calculated to obtain the main values lambda λᵥ₁ and λᵥ₂, and the corresponding principal axes are pᵥ₁₁, pᵥ₁₂, pᵥ₂₁, and pᵥ₂₂ respectively.

In the example, with mark point P₁ as an instance, data of the main values and the principal axes of the elongation matrix of P₁ are shown in Table 4 respectively, and it may be found that λᵤ₁=λᵥ₁λ₁ and λᵤ₂=λᵥ₂=λ₂ in the table.

TABLE 7
Main values and corresponding principal axes
of elongation tensor matrix of mark point P₁

| Main value λ | | Principal axis pᵤ | | | | Principal axis p_{ν} | | | |
|---|---|---|---|---|---|---|---|---|---|
| λ₁ | λ₂ | Pᵤ₁₁ | Pᵤ₁₂ | Pᵤ₂₁ | Pᵤ₂₂ | p_{ν11} | P_{ν12} | P_{ν21} | P_{ν22} |
| 0.6892 | 2.0871 | 0.2658 | 0.9940 | −0.9640 | 0.2658 | 0.1075 | 0.9940 | −0.9940 | 0.1075 |

Main values and principal axes of the right strain tensor matrix [H] are calculated to obtain the main values λ_{H1} and λ_{H2}, and the corresponding principal axes are p_{H11}, p_{H12}, p_{H21}, and p_{H22} respectively. Main values and principal axes of the left strain tensor matrix [h] are calculated to obtain the main values λ₁ and λₕ₂, and the corresponding principal axes are pₕ₁₁, pₕ₁₂, pₕ₂₁, and pₕ₂₂ respectively.

In the example, with mark point P₁ as an instance, data of the main values and the principal axes of the strain matrix of P₁ are shown in Table 6 respectively. Obviously, λ_{H1}=λₕ₁=λ₁ and λ_{H2}=λₕ₂=λ₂ in the table.

TABLE 8
Main values and corresponding principal axes of strain tensor matrix of mark point P₁

| Main value λ | | Principal axis p_{H} | | | | Principal axis pₕ | | | |
|---|---|---|---|---|---|---|---|---|---|
| λ₁ | λ₂ | P_{H11} | P_{H12} | P_{H21} | P_{H22} | Pₕ₁₁ | pₕ₁₂ | pₕ₂₁ | pₕ₂₂ |
| 0.6278 | 1.7358 | −0.2658 | −0.9640 | −0.9640 | 0.2658 | −0.1075 | −0.9940 | −0.9940 | 0.1075 |

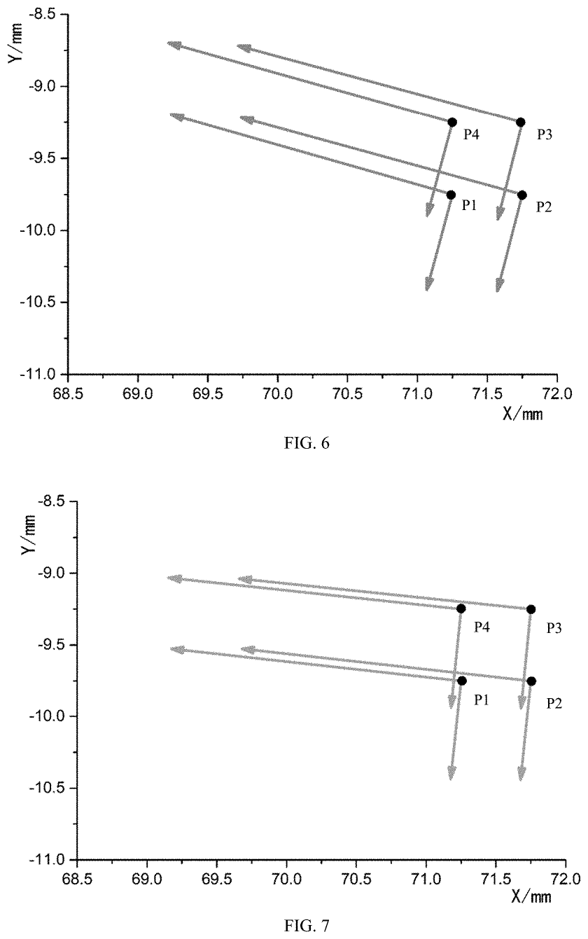

The vector diagram of the principal axes and the main values of the right elongation tensor [U] of mark points P₁, P₂, P₃ and P₄ are shown in FIG. 6, and the vector diagram of the principal axes and the main values of the left elongation tensor [V] are shown in FIG. 7.

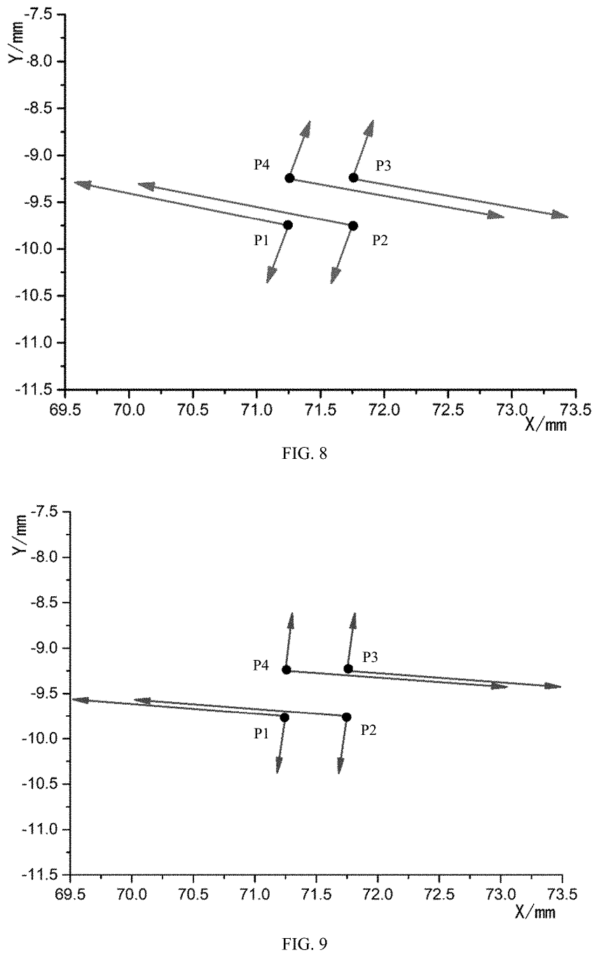

The vector diagram of the principal axes and the main values of the right strain tensor [H] of mark points P₁, P₂, P₃ and P₄ are shown in FIG. 8, and the vector diagram of the principal axes and the main values of the left strain tensor [h] are shown in FIG. 9.

(3) Characterization of Rotation Angle

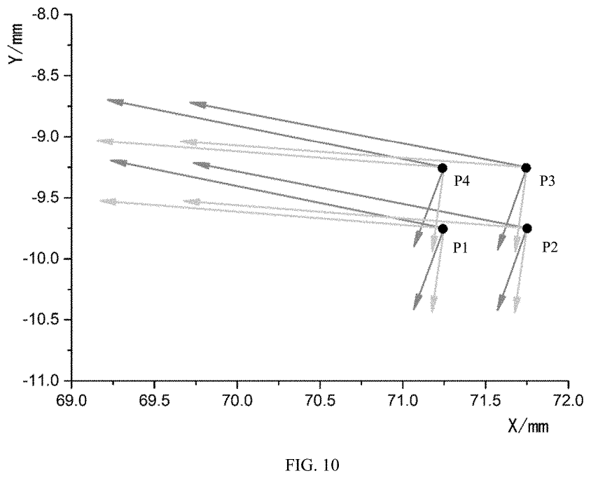

The rotation angles a of mark points P₁, P₂, P₃ and P₄ are included angles between the principal axes of [U] and [V], and characterization of the rotation angles α is shown in FIG. 10.

It must be noted that the method and technology for determining deformation measurement parameters with respect to a unidirectional tensile test piece involved in the present invention is suitable for the case in which a flat test piece is stretched in any stretching direction.

What is claimed is:

1. A method for measuring a super-large deformation of a plane, comprising the steps of
arranging enough mark points for an image recognition on a plane of a test piece to be measured;
recognizing and recording positions of two-dimensional Cartesian coordinates of each mark point on the plane of the test piece to be measured before and after each stretching; and
determining a deformation gradient of each mark point and deformation measurement parameters of each mark point by using a numerical method,
wherein the deformation measurement parameters comprise:
at least one of an elongation tensor matrix and a finite strain tensor matrix; and
at least one selected from the group consisting of an orthogonal tensor matrix, an angular tensor matrix, a rotation angle, and a curvature.

2. The method according to claim 1, wherein the curvature of one mark point is calculated according to a variation of the rotation angle of an adjacent mark point.

3. The method according to claim 1, wherein a deformation gradient matrix [F] of each mark point is calculated, if a forward difference method is used, an instance is shown as follows:
any mark point is taken as P₁, an adjacent mark point of a mark point in an X-axis direction is P₂, an adjacent mark point in a Y-axis direction is P₄, the two-dimensional Cartesian coordinates before deformation are (X₁, Y₁), (X₂, Y₂) and (X₄, Y₄) respectively, for the three mark points (P₁, P₂, and P₄), the two-dimensional Cartesian coordinates after deformation are (x₁, y₁), (x₂, y₂) and (x₄, y₄) respectively, and
the deformation gradient matrix of the mark point P₁ is:
$$[ {F}_{1} ] = [ \begin{matrix}{F}_{11} & {F}_{12} \\ {F}_{21} & {F}_{22}\end{matrix} ] = [ \begin{matrix}\frac{{x}_{2} - {x}_{1}}{{X}_{2} - {X}_{1}} & \frac{{x}_{4} - {x}_{1}}{{Y}_{4} - {Y}_{1}} \\ \frac{{y}_{2} - {y}_{1}}{{X}_{2} - {X}_{1}} & \frac{{y}_{4} - {y}_{1}}{{Y}_{4} - {Y}_{1}}\end{matrix} ] .$$

4. The method according to claim 1, wherein formulas of
[U]=\sqrt{[F]^{T}·[F]}
[V]=\sqrt{[F]·[F_{]}^{T}}
are configured for determining a right elongation tensor matrix [U] and a left elongation tensor matrix [V] of each mark point.

5. The method according to claim 1, wherein formulas of
[H]=ln[U]
[h]=ln[V]
are configured for determining the finite strain tensor matrix of each mark point, comprising a right strain tensor matrix [H] and a left strain tensor matrix [h].

6. The method according to claim 1, wherein a formula of
[R]=[F]·[U]⁻¹
is configured for determining the orthogonal tensor matrix [R] of each mark point.

7. The method according to claim 1, wherein a formula of
$$[ A ] = ln [ R ] = [ \begin{matrix}0 & {A}_{12} \\ - {A}_{12} & 0\end{matrix} ]$$
is configured for determining the angular tensor matrix [A] of each mark point, and a rotation angle value of each mark point is determined as α=−A₁₂.

8. The method according to claim 2, wherein components of the curvature C of mark point P₁ are C₁₁ and C₁₂ respectively, specific calculations are as follows:
$${C}_{11} = \frac{{α}_{2} - {α}_{1}}{{X}_{2} - {X}_{1}} , {C}_{12} = \frac{{α}_{4} - {α}_{1}}{{Y}_{4} - {Y}_{1}} ,$$
and
α₁, α₂ and α₄ are the rotation angles of mark points P₁, P₂ and P₄ respectively.

9. The method according to claim 1, wherein all the mark points are uniformly distributed on one part or all parts of the plane to be measured.

10. The method according to claim 1, further comprising the step of performing a pre-stretching operation on the plane to be measured in a natural state to obtain a plane to be measured in a tensioned state as a whole in a stretching direction, wherein coordinate positions of mark points on the plane to be measured in such a state serve as initial positions of the mark points.

11. The method according to claim 1, wherein the mark points are almost circular, and a ratio of a mark point diameter to a mark point spacing is about 1:2 to 1:4.
